(19) United States
(12) Patent Application Publication
(10) Pub. No.: US 2009/0245374 A1
(43) Pub. Date: Oct. 1, 2009

(54) VIDEO ENCODER AND MOTION ESTIMATION METHOD

(75) Inventors: Chih-Wei Hsu, Taipei City (TW); Yu-Wen Huang, Taipei City (TW); To-Wei Chen, Taoyuan Country (TW); Chih-Hui Kuo, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/055,353

(22) Filed: Mar. 26, 2008

(51) Int. Cl. H04N 7/26; H04N 5/14

(52) U.S. Cl. 375/240.16; 348/699; 348/E05.062; 375/E07.124

(57) ABSTRACT

A video encoder and a motion estimation method are provided. The video encoder comprises a storage unit and an integer motion estimation unit. The storage unit receives a current image block and a plurality of search windows from at least two reference frames. The integer motion estimation unit coupled to the storage unit computes a plurality of integer motion vectors according to the current image block and the plurality of search windows. A number of the reference frames and a size of the search windows are adaptively changed such that space requirement thereof is less than or equal to available space in the storage unit.

### BACKGROUND OF THE INVENTION

1. Field of the Invention

The invention relates in general to video coding, and in particular, to a video encoder and motion estimation method.

2. Description of the Related Art

Block-based video coding standards such as MPEG 1/2/4 and H.26x achieve data compression by reducing temporal redundancies between video frames and spatial redundancies within a video frame. Encoders conforming to the standards produce a bitstream decodable by other standard compliant decoders. These video coding standards provide flexibility for encoders to exploit optimization techniques to improve video quality.

One area of flexibility given to encoders is with frame type. For block-based video encoders, three frame types can be encoded, namely I, P and B-frames. An I-frame is an intra-coded frame without any motion-compensated prediction (MCP). A P-frame is a predicted frame with MCP from previous reference frames and a B-frame is a bi-direction predicted frame with MCP from previous and future reference frames. Generally, I and P-frames are used as reference frames for MCP.

Inter-coded frames, including P-frames and B-frames, are predicted via motion compensation from previously coded frames to reduce temporal redundancies, thereby achieving high compression efficiency. Each video frame comprises an array of pixels. A macroblock (MB) is a group of pixels, e.g., 16×16, 16×8, 8×16, and 8×8 block. The 8×8 block can be further sub-partitioned into block sizes of 8×4, 4×8, or 4×4. Thus, 7 block types are supported in total. It is common to estimate how the image has moved between the frames on a macroblock basis, referred to as motion estimation. Motion Estimation typically comprises comparing a macroblock in the current frame to a number of macroblocks from other reference frames for similarity. The spatial displacement between the macroblock in the current video frame and the most similar macroblock in the reference frames is a motion vector. Motion vectors may be estimated to within a fraction of a pixel, by interpolating pixel from the reference frames.

FIGS. 1a and 1b illustrate a conventional motion estimation process searching search window 14 in reference (previous) frame 13 to find matched image block 15 for image block 12 in current frame 11, where image block 16 has moved from the previous position 15 to the new position 16 by motion vector 17. A motion vector (MV) represents a displacement of an image block from a reference frame to a current frame. A block matching metric, such as Sum of Absolute Differences (SAD) or Mean Squared Error (MSE), can be used to determine the level of similarity between the current block and an image block in the reference frame. The location in the reference frame which produces the minimum SAD or MSE is taken to be the position of best match, and the minimum SAD or MSE is taken as the motion vector. The image block in the current frame is a macroblock.

In addition to using search windows to reduce spatial redundancy, MPEG 4 coding also adopts multi-reference frames to reduce temporal redundancy for motion estimation. Thus, a need exists for a video encoder and a method for performing motion estimation by an adaptive combination of multiple reference frames and search windows.

### BRIEF SUMMARY OF THE INVENTION

A detailed description is given in the following embodiments with reference to the accompanying drawings.

A video encoder capable of motion estimation is disclosed, comprising a storage unit and an integer motion estimation unit. The storage unit receives a current image block and a plurality of search windows from at least two reference frames. The integer motion estimation unit coupled to the storage unit computes a plurality of integer motion vectors according to the current image block and the plurality of search windows. A number of the reference frames and a size of the search windows are adaptively changed such that space requirement thereof is less than or equal to available space in the storage unit.

According to another embodiment of the invention, a method of motion estimation is provided, comprising providing a storage unit receiving a current image block and a plurality of search windows from at least two reference frames, and providing an integer motion estimation unit computing a plurality of integer motion vectors according to the current image block and the plurality of search windows, and wherein a number of the reference frames and a size of the search windows are adaptively changed such that space requirement thereof is less than or equal to available space in the storage unit.

### BRIEF DESCRIPTION OF THE DRAWINGS

The invention can be more fully understood by reading the subsequent detailed description and examples with references made to the accompanying drawings, wherein:

FIGS. 1a and 1b illustrate a conventional motion estimation process.

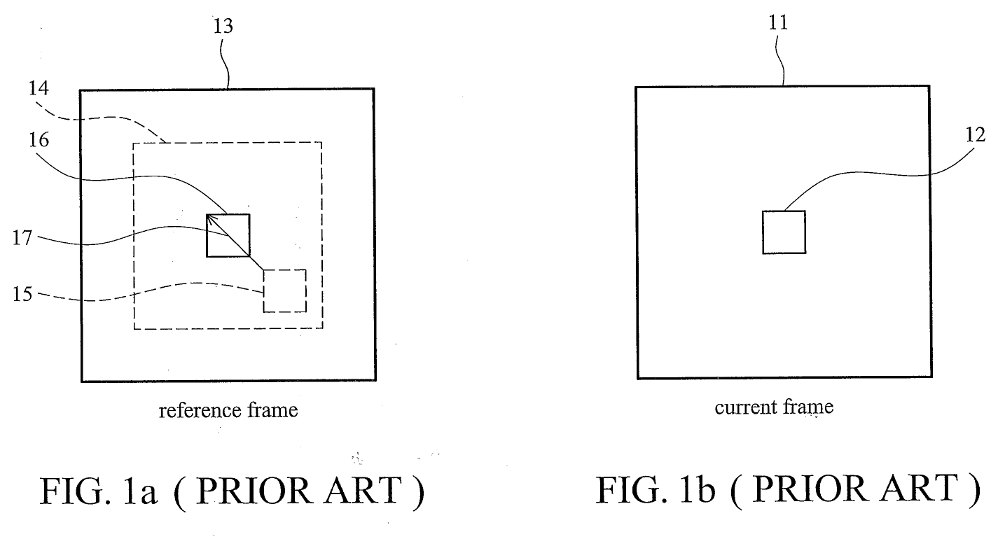

FIG. 2 shows a motion estimation process for frame and field modes in MPEG encoding.

FIGS. 3a and 3b depict block diagrams of an exemplary video encoder capable of motion estimation according to the invention.

FIGS. 4a and 4b depict block diagrams of another exemplary video encoder according to the invention.

FIGS. 5a and 5b depict block diagrams of still another exemplary video encoder according to the invention.

FIGS. 6a and 6b depict block diagrams of yet another exemplary video encoder according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

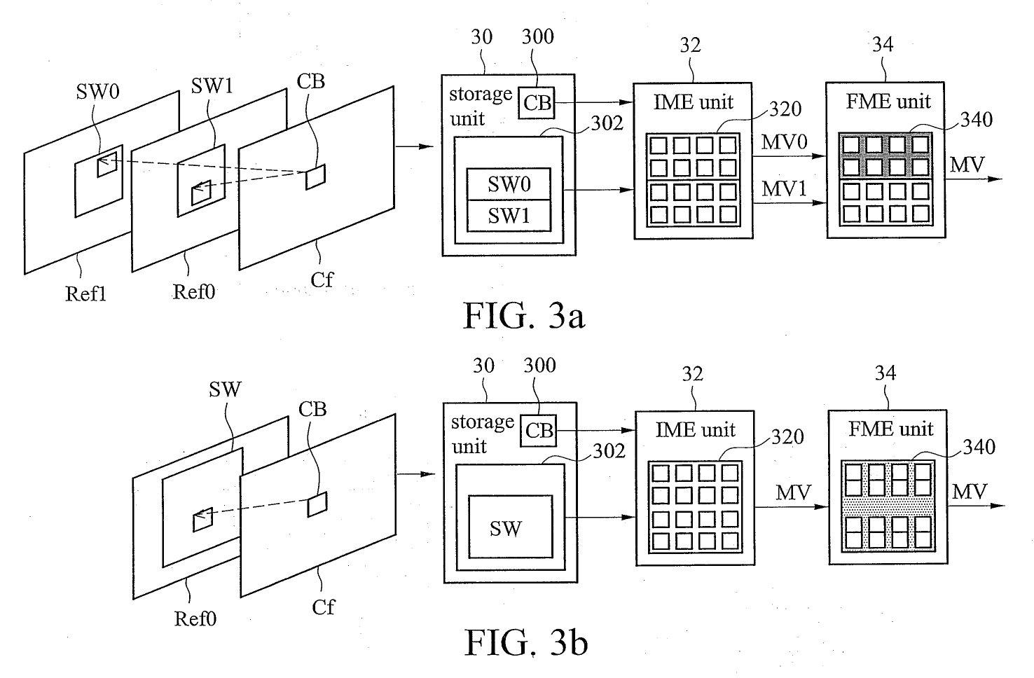

FIGS. 3a and 3b are block diagrams of an exemplary video encoder capable of motion estimation according to the invention, comprising a storage unit 30, an integer motion estimation unit 32, and a fractional motion estimation unit 34, wherein the storage unit 30 is coupled to the integer motion estimation unit 32, and subsequently to the fractional motion estimation unit 34.

The storage unit 30 comprises a memory 300 receiving a current image block CB, and a memory 302 receiving search windows SW0 and SW1 (a plurality of search windows) from reference frames Ref0 and Ref1 (at least two reference frames). Though only two search windows and two reference frames are shown in FIG. 3a, there may be more search windows and reference frames. The current image block CB is a macroblock, and may be an 8×8 macroblock including 64 pixels to be searched. Search windows SW0 and SW1 comprise pixels to be searched for one match with the current image block CB. Memories 300 and 302 may be any computer accessible memory such as DRAM, SRAM, or Flash memory.

The integer motion estimation unit 32 comprises a processing element (PE) array 320 receiving the current image block CB and search windows SW0 and SW1, and computing integer motion vectors MV0 and MV1 (a plurality of MVs), accordingly, thereto. Each PE is the smallest processing unit that receives pixels of the current image block CB to be searched and a search range of the search window to search from, and calculates an SAD. The search range in each PE may differ from that in an adjacent PE by 1 pixel. The PE array 320 obtains a distortion value for each PE by calculating a SAD between the current image block CB and each search range in search windows SW0 and SW1, and determines a minimum SAD for each search window as an integer motion vector. The PE array 320 calculates SADs for search windows SW0 and SW1 to output integer motion vectors MV0 and MV1. The number of the reference frames and the size of the search windows can be adaptively changed such that the space requirement of the search windows in all reference frames is less than or equal to the available space in the storage unit 30. For example, when the number of the reference frames is small, the size of the search window may be adaptively changed to cover large area, and when the number of the reference frames is large, the size of the search window may be adaptively changed to cover small area.

The fractional motion estimation unit 34 comprises a PE array 340 computing a fractional motion vector by interpolating the pixels in the search range that produces the integer motion vector with adjacent pixels thereof to estimate interpolated search ranges, and calculating a SAD between the pixels in the current image block CB and each interpolated search range to determine a minimum SAD thereof as the fractional motion vector MV. Each PE receives the pixels in the current image block CB and an interpolated search range with different interpolation positions to calculate a SAD. The PE array 340 calculates SADs for search windows SW0 and SW1, and selects a minimum therefrom to output the fractional motion vector MV.

The video encoder in FIGS. 3a and 3b is back-compatible with the legacy MPEG standards such as MPEG 2, as illustrated in FIG. 3b, where only a single reference frame is used for prediction coding. The storage unit 30 receives the current image block CB from the current frame CF at the memory 300 and the search window SW from the reference frame Ref0 at the memory 302. The integer motion estimation unit 32 obtains pixels in the current image block CB and the search window SW to determine the integer motion vector MV. Then the fractional motion estimation unit 34 interpolates the pixels in the search range that generates the integer motion vector MV to compute the fractional motion vector MV. Since only one search window SW is stored in the memory 302, the maximal size of the search window SW is larger in comparison to either search windows SW0 or SW1.

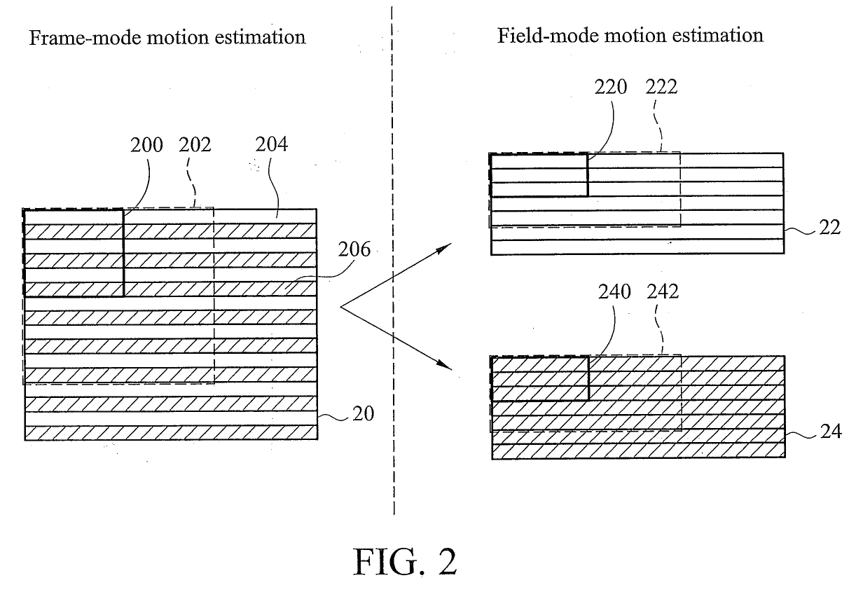

The video encoder in FIG. 2 is also compatible with the field mode in MPEG coding. FIG. 2 shows a motion estimation process for frame and field modes in MPEG encoding. The left hand side of FIG. 2 shows a current image frame 20 comprising two interlaced fields, namely, the odd field 204 and the even field 206. A frame based search is performed in the search window 202 from a reference image frame with the location of the lowest frame based SAD representing the best frame-based image block matched with current image block 200. As shown in the right hand side of FIG. 2, for field based motion estimation, the macroblock of the current image frame is divided into two blocks 22 and 24, each contains only even fields (block 22) or only odd fields (block 24). Search window 202 is also divided into reference image blocks 222 and 242, one contains only odd field lines and the other contains only even field lines to perform the motion estimation process separately. Namely the video encoder in FIGS. 3a and 3b performs the motion estimation to search the odd current image block 220 from the odd reference image block 222, and search the even current image block 240 from the odd reference image block 242. In one embodiment, the memory 300 receives even and odd field blocks (not shown) in the current image block CB, and the memory 302 receives search windows SW0 and SW1 for the even and odd field blocks from a reference frame. Each PE in the integer motion estimation unit 32 then calculates and outputs minimum SADs for even and odd field blocks for motion vectors MV0 and MV1. And the fractional motion estimation unit 34 further calculates the fractional motion vector by interpolation to generate a minimum SAD among all the calculations for the final motion vector MV.

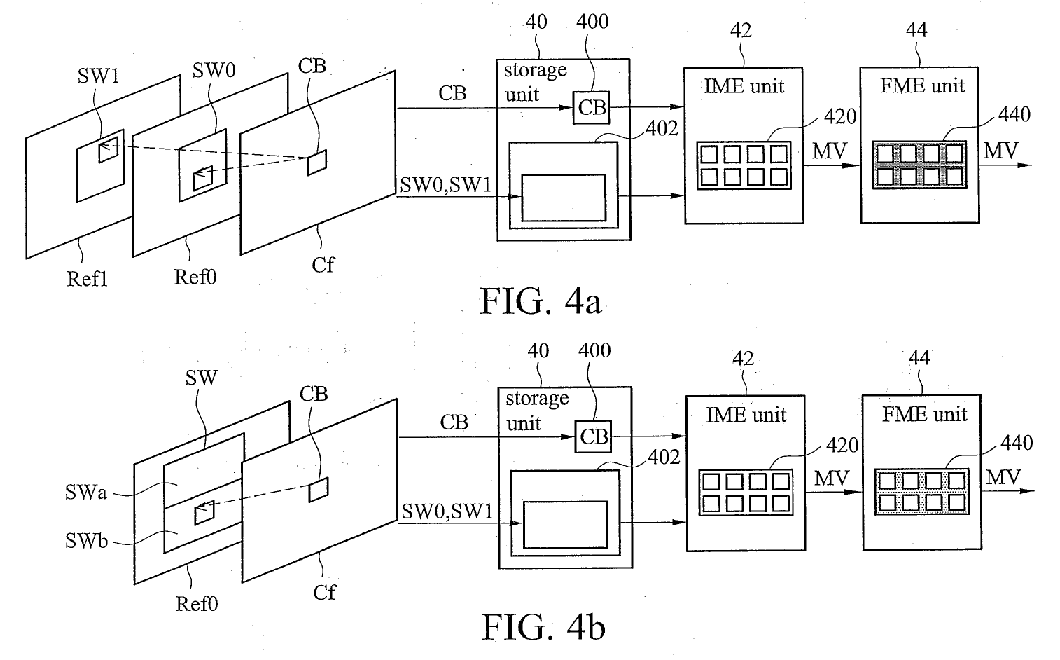

FIGS. 4a and 4b are block diagrams of another exemplary video encoder according to the invention, comprising a storage unit 40, an integer motion estimation unit 42, and a fractional motion estimation unit 44, wherein the storage unit 40 is coupled to the integer motion estimation unit 42, then to the fractional motion estimation unit 44.

The video encoder in FIGS. 4a and 4b is capable of performing prediction coding for multi-frame reference and a large search window size under a hardware resources limited condition. In an example of multi-frame reference, search windows SW0 and SW1 are sequentially entered to the storage unit 40, the integer motion estimation unit 42, and the fractional motion estimation unit 44, respectively. Then the data buffering, integer motion vector estimation and fractional motion vector computation are carried out for search windows SW0 and SW1 by pipeline to output a fractional motion vector MV for current image block CB. Since only half of the hardware for the video encoder in FIGS. 3a and 3b is required, a compact circuit design is produced and manufacturing costs are reduced. Similarly, when a search window size exceeds the available space of the storage unit 40, the integer motion estimation unit 42 and fractional motion estimation unit 44, the units 40, 42 and 44 would receive pixels in half search windows SWa and SWb in sequence, and performs data buffering, integer motion vector estimation and fractional motion vector computation by pipeline to output the fractional motion vector MV of current image block CB. The hardware requirements are reduced at the expense of increased data processing time.

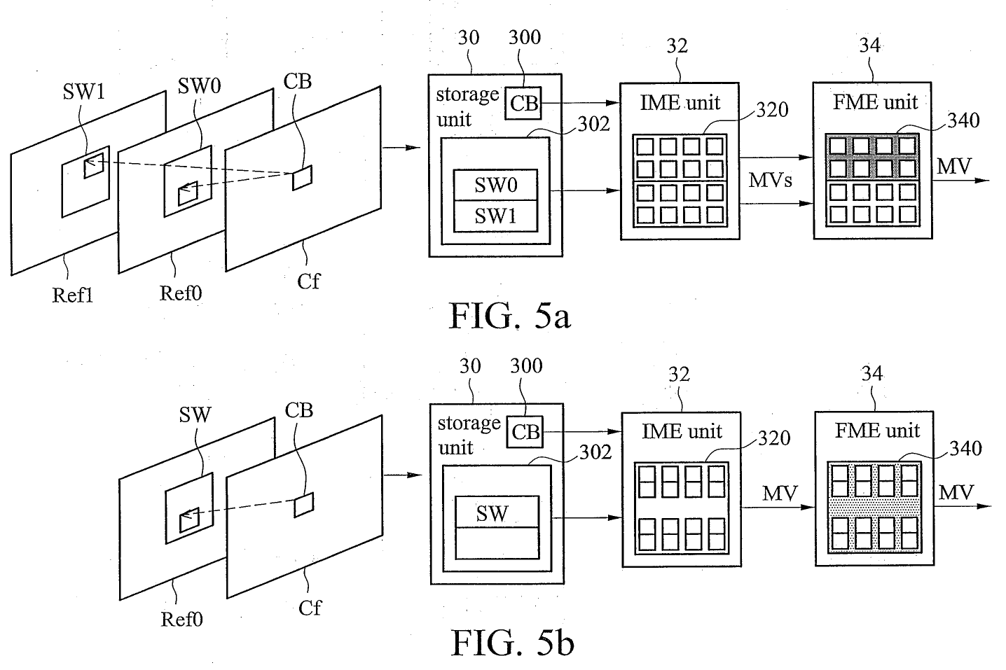

FIGS. 5a and 5b are block diagrams of still another exemplary video encoder according to the invention, comprising a storage unit 30, an integer motion estimation unit 32 and a fractional motion estimation unit 34 identical to those shown in FIGS. 3a and 3b. FIG. 5a is an video encoder identical to FIG. 3a, where current image block CB and at least two search windows SW0 and SW1 from two separate reference frames are stored in storage unit 300, then the plurality of integer motion vectors MV0 and MV1 according to current image block CB and search windows SW0 and SW1 are computed in IME unit 32, and integer motion vectors MV0 and MV1 are further interpolated to output a fractional motion vector MV by FME unit 34. Referring to FIG. 5b, owning to a smaller search window size, the storage unit 30 receives the search window SW, which occupies only half the available space of the memory 302. In comparison to full hardware utilization in FIGS. 3a and 3b, only half the hardware resources of the storage unit 30, the integer motion estimation unit 32 and the fractional motion estimation unit 34 are used for operations in FIGS. 5a and 5b, resulting in faster fractional motion vector computations in the fractional motion estimation unit 34.

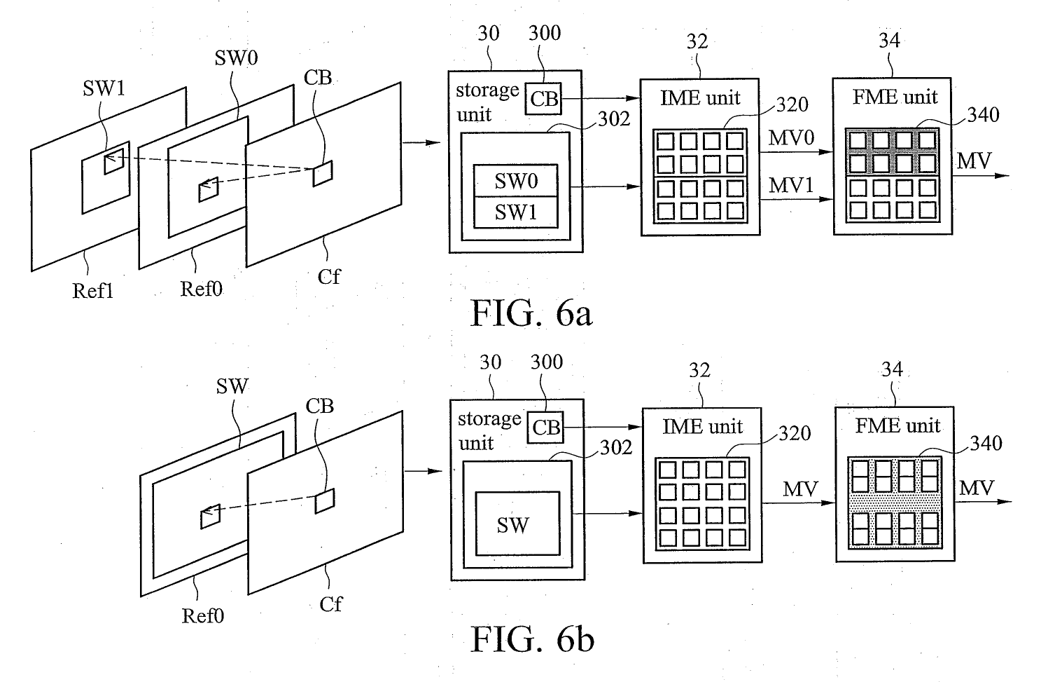

FIGS. 6a and 6b are block diagrams of yet another exemplary video encoder according to the invention, comprising a storage unit 30, an integer motion estimation unit 32 and a fractional motion estimation unit 34 identical to those shown in FIGS. 3a and 3b. Referring to FIG. 6a for another multi-reference example in MPEG coding. Reference windows Ref 0 and Ref1 comprise search windows SW0 and SW1 with different search window sizes. The size of the search window SW0 exceeds that of the search window SW1. Thus, in comparison to FIGS. 3a and 3b, the memory 300 and the PE arrays 320 and 340 need more space and operating units to process all pixels of search windows SW0 and SW1 in parallel and output the fractional motion vector MV for the current image block CB. FIG. 6b shows an exemplary video encoder encoding video frame Cf using larger search window SW comparatively to search window SW in FIG. 3b. Since the larger SW includes more picture pixels, it requires more space in memory 302 and more processing elements in IME unit 32 and FME unit 34 to calculate for SADs between current block CB and data in search window SW. The encoder allocates the memory space and the number of the processing elements required for pixel data in search window SW according to the search window size.

The processing elements (PEs) in FIGS. 3a˜6b are reconfigurable. They may process multiple frames parallelly, process one frame at a time collectively, or work in any other way adapted to different situations.

While the embodiments disclosed herein employ MPEG standards, those skilled in the art could recognize that other video coding standards such as H.263 and H.264 are equally applicable using the disclosed video encoder and motion estimation method, with modification to where appropriate.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video encoder capable of motion estimation, comprising:
a storage unit, receiving a current image block and a plurality of search windows from at least two reference frames; and
an integer motion estimation unit coupled to the storage unit, computing a plurality of integer motion vectors according to the current image block and the plurality of search windows; and
wherein a number of the reference frames and a size of the search windows are adaptively changed such that space requirement thereof is less than or equal to available space in the storage unit.

2. The video encoder of claim 1, wherein the integer motion estimation unit calculates Sum of Absolute Differences (SADs) between the current image block and each reference image block in the plurality of search windows, and determines a minimum SAD for each search window as the integer motion vector.

3. The video encoder of claim 2, further comprising a fractional motion estimation unit coupled to the integer motion estimation unit, wherein the fractional motion estimation unit interpolates the pixels in the reference image block corresponding to the integer motion vector with adjacent pixels thereof to estimate interpolated reference image blocks, and calculates SADs between the current image block and each interpolated reference image block to determine a minimum SAD thereof for each search window as a fractional motion vector.

4. The video encoder of claim 1, wherein the integer motion estimation unit computes the plurality of integer motion vectors concurrently or sequentially.

5. The video encoder of claim 1, wherein the plurality of search windows have identical or different sizes, such that available space of the storage unit exceeds or equals to space requirement of the current image block and the plurality of search windows.

6. The video encoder of claim 1, wherein the search windows of each reference frame comprises even and odd fields, and the integer motion estimation unit computes even and odd integer motion vectors according to the current image block and the even and odd fields, and calculates an average of the even and odd integer motion vectors for the integer motion vector of each reference frame.

7. The video encoder of claim 1, wherein the storage unit comprises a plurality of sub-storage units and the IME unit comprises a plurality of sub-IME units, each sub-storage unit receives the current image block or each search windows from each reference frame, and each IME unit computes the integer motion vector according to the current image block and each search window.

8. A method of motion estimation, comprising:
providing a storage unit receiving a current image block and a plurality of search windows from at least two reference frames; and
providing an integer motion estimation unit computing a plurality of integer motion vectors according to the current image block and the plurality of search windows; and
wherein a number of the reference frames and a size of the search windows are adaptively changed such that space requirement thereof is less than or equal to available space in the storage unit.

9. The method of claim 8, wherein the step of providing an integer motion estimation unit comprises calculating Sum of Absolute Differences (SAD) between the current image block and each reference image block in the plurality of search windows, and determining a minimum SAD for each search window as the integer motion vector.

10. The method of claim 9, further comprising providing a fractional motion estimation unit interpolating the pixels in the reference image block corresponding to the integer motion vector with adjacent pixels thereof to estimate interpolated reference image blocks, and calculating SADs between the current image block and each interpolated reference image block to determine a minimum SAD thereof for each search window as a fractional motion vector.

11. The method of claim 8, wherein the step of providing an integer motion estimation unit comprises computing the plurality of integer motion vectors concurrently or sequentially.

12. The method of claim 8, wherein the plurality of search windows have identical or different sizes, such that available space of the storage unit exceeds or equals to space requirement of the current image block and the plurality of search windows.

13. The method of claim 8, wherein the search windows of each reference frame comprises even and odd fields, and the step of providing an integer motion estimation unit comprises computing even and odd integer motion vectors according to the current image block and the even and odd fields, and calculating an average of the even and odd integer motion vectors for the integer motion vector of each reference frame.
